(19) United States
(12) Patent Application Publication
(10) Pub. No.: US 2005/0070385 A1
(43) Pub. Date: Mar. 31, 2005

(54) Vehicle speed limiting apparatus

(76) Inventor: Jyh-Kuo Chorng, Kaohsiung City (TW)

Correspondence Address: Leong C. Lei, PMB#1008, 1867 Ygnacio Valley Rd., Walnut Creek, CA, 94598, US

(21) Appl. No.: 10/727,572

(22) Filed: Dec. 5, 2003

(30) Foreign Application Priority Data
Sep. 30, 2003 (TW) 092217586

(51) Int. Cl. F16H 55/56; F16H 59/00; F16H 63/00

(52) U.S. Cl. 474/15; 474/12; 474/8; 474/17

(57) ABSTRACT

A vehicle speed limiting apparatus has added a limiting ring to a belt transmission in the vehicle to limit the travel of a passive disk in the belt transmission to achieve the purpose of speed limitation for the vehicle while permitting the maximal torque output during acceleration or climb.

### BACKGROUND OF THE INVENTION

(a) Technical Field of the Invention

The present invention is related to a vehicle speed limiting apparatus, and more particularly to one having a limiting ring added to a belt transmission to limit the speed without reducing the torque of the vehicle.

(b) Description of the Prior Art

FIG. 1 of the accompanying drawings shows a belt transmission 2 adapted to a vehicle generally available in the market, such as a motorcycle or a land vehicle. Wherein, the belt transmission 2 is disposed in a transmission case 11, and the power from an engine 12, which is transferred via a crankshaft 13 in a crankcase 15, drives the belt transmission 2. The belt transmission 2 includes a slide disk 21 disposed on the crankshaft 13; an active disk 22 disposed to the crankshaft 13 on the side of the slide disk 21; a taper plate 23 disposed to the crankshaft 13 on the other side of the slide disk 21; a counter weight ball 24 at where restricted between the slide disk 21 and the taper plate 23; a passive disk 26 disposed on a driven shaft 25 to transmit power to the driven shaft; a clutch 27 fixed to the driven shaft 25; and a bearing 29 disposed on a transmission case cover 111 of the transmission case 11 to support the driven shaft 25. Wherein, the slide disk 21 and the active disk 22 constitute an active disk for the belt transmission 2. One end of the belt 28 is located between the active disk 22 and the slide disk 21 while the other end of the belt 28 is located between the active disk 22 and the passive disk 26.

The engine 12 produces the power from explosions in the combustion chamber to push the piston 14 to conduct reciprocal movements, thus to drive the crankshaft 13 to rotate while both the slide disk 21 and the active disk 22 synchronously rotate. Meanwhile, the counterweight ball 24 moves for being subject to eccentric force. When throttled up, the rpm of the crankshaft 13 increases accordingly to throw the counterweight ball 24 out of its initial position to be subject to a greater eccentric force, and the slide disk 21 to be subject to the force by the counterweight ball 24 moves towards the active disk 22 to narrow the distance between the active disk 22 and the slide disk 21, thus enabling the transmission belt 28 to expand the circumferential range of its rotation. Consequently, the rpm of the passive disk 26 is increased to further increase the speed of the vehicle via the acceleration of the driven shaft 25 driven by the clutch 27.

In contrast, in the case of throttle-down, the counterweight ball 24 is subject to a lesser eccentric force which increases the distance between the active disk 22 and the slide disk 21 in conjunction with the compression exercised by the transmission belt 28, resulting in a reduced range of the circumferential rotation of the transmission belt 28. Consequently, the rpm of the passive disk 26 is reduced to lower the rpm transmitted to the rear wheel(s), thus slowing down the vehicle.

In certain countries, a speed limit is prescribed for vehicles. For the purposes of compliance, a speed limit apparatus is usually adapted to the vehicle. A speed limiting structure of the prior art as illustrated in FIG. 2, has a speed-limiting pipe 32 extending from an exhaust conduit 31 of an exhaust pipe 3 disposed below the engine 12. The speed-limiting pipe 32 is generally a type of curved and closed metal pipe. Part of the exhaust resulting from the engine 12 is discharged from the outlet through the exhaust conduit 31 and another part of the exhaust will flow into and hit the bottom of the speed-limiting pipe 32, then bounce back into the exhaust conduit 31 to create a disturbance at the open end of the speed-limiting pipe 32 as illustrated in FIG. 3. The high-pressure exhaust discharged from the outlet of the exhaust forms a resistance by the disturbance. Whereas a two-stroke engine running at higher rpm's takes advantage of the disturbance to harmonize the exhaust, in the case of a four-stroke engine, the speed limiting effect is prevented due to the counter pulsation being too small, and so the speed limiting method described above is applicable only to two-stroke engines and is not applicable to four-stroke engines. The exhaust from the engine 12 is at an extremely high temperature, making the speed-limiting pipe 32 prone to being deformed by the exhaust. The speed-limiting pipe 32 is also vulnerable to damage due to impact resulting from the speed limiting effect not being stable and the torque of the engine 12 dropping.

### SUMMARY OF THE INVENTION

The primary purpose of the present invention is to provide a vehicle speed limiting apparatus by adding a limiting ring to the belt transmission to limit the travel of the passive disk in the belt transmission to limit the vehicle speed without compromising the torque of the engine.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a vehicle engine and a transmission of the prior art.

FIG. 2 is a schematic view showing a speed-limiting structure of the prior art.

FIG. 3 is a schematic view showing a local part of the airflow in the speed-limiting structure of the prior art.

FIG. 4 is a schematic view showing a preferred embodiment of the present invention.

FIG. 5 is a blow-up view of a local part of the preferred embodiment of the present invention.

FIG. 6 is an exploded view of a limiting ring and a passive disk of the preferred embodiment of the present invention.

FIG. 7 is a schematic view showing the combination of the limiting ring and the passive disk of the preferred embodiment of the present invention.

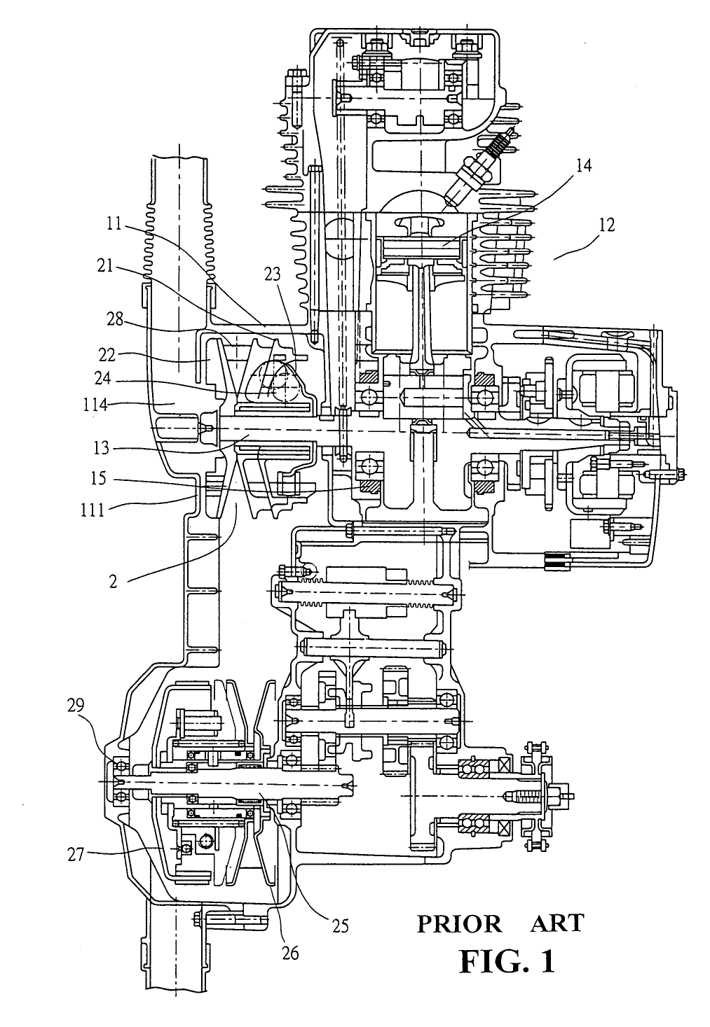

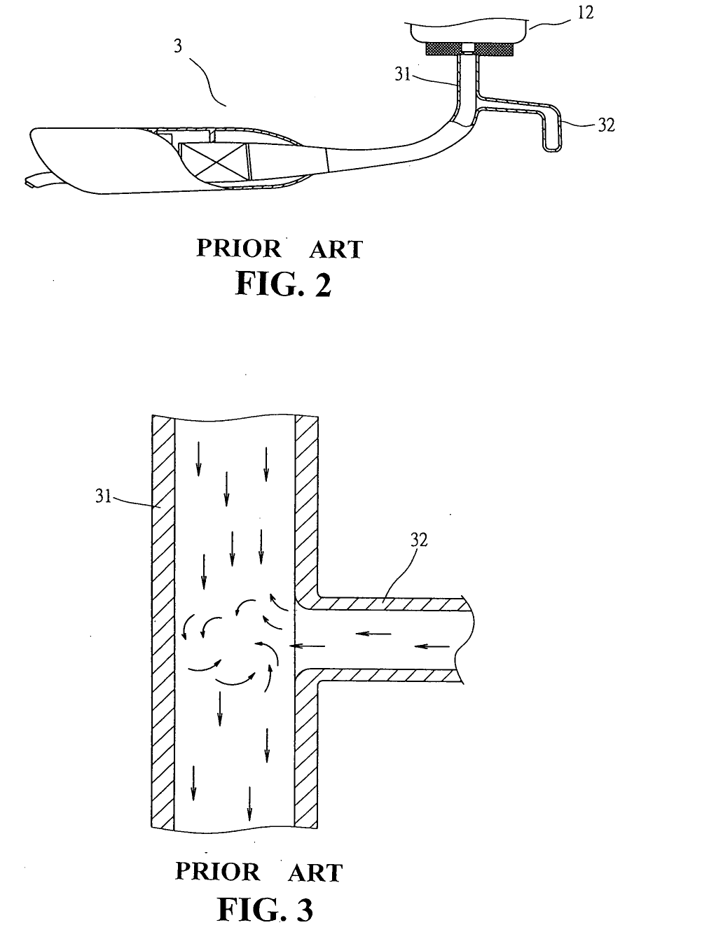

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

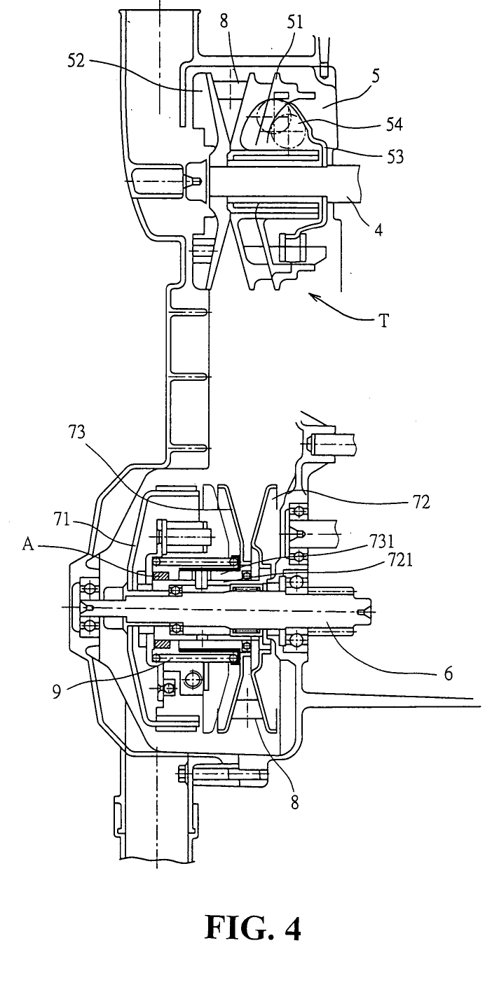

Referring to FIG. 4 for a speed limiting structure of the present invention, a limiting ring A is disposed in a belt transmission T. The belt transmission T includes a slide disk 51 disposed on a crankshaft 4; an active disk 52 disposed on the crankshaft 4 on the side of the slide disk 41; a taper plate 53 disposed on the crankshaft 4 on the other side of the slide disk 51; a counter weight ball 54 accommodated and restricted between the slide disk 51 and the taper plate 53; two passive disks 72 and 73 disposed on a passive shaft 6; a clutch 71 fixed to the passive shaft 6; and a transmission belt 8. Wherein, the slide disk 51 and the active disk 52 define an active disk 5 of the belt transmission T. One end of the transmission belt 8 is located between the active disk 52 and the slide disk 51 while the other end of the transmission belt 8 is located between those two passive disks 72 and 73.

A guide part 721 inserted onto the passive shaft 6 is provided to the passive disk 72, and a guide cylinder 731 inserted onto the guide part 721 of the passive disk 72 is disposed to another passive disk 73. A distance for movement is defined for the passive disk 73 between the guide cylinder 731 and the clutch 71 for the guide cylinder 731 of the passive disk 73 to move on the guide part 721 of the passive disk 72. A spiral coil 9 is inserted between the outer side of the guide cylinder 731 of the passive disk 73 and the clutch 71.

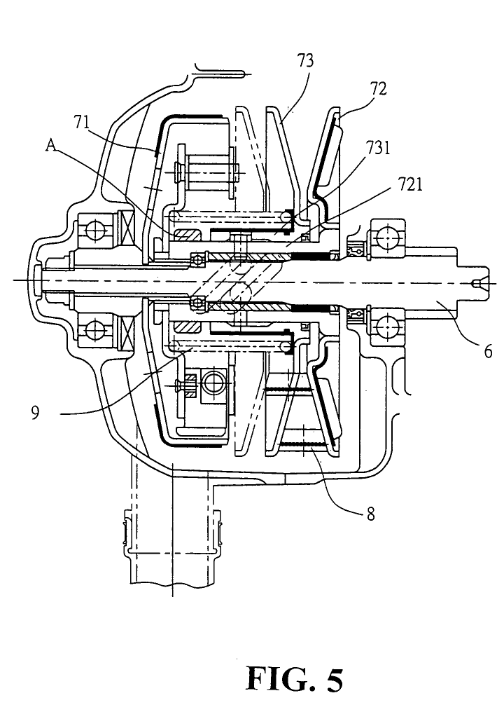

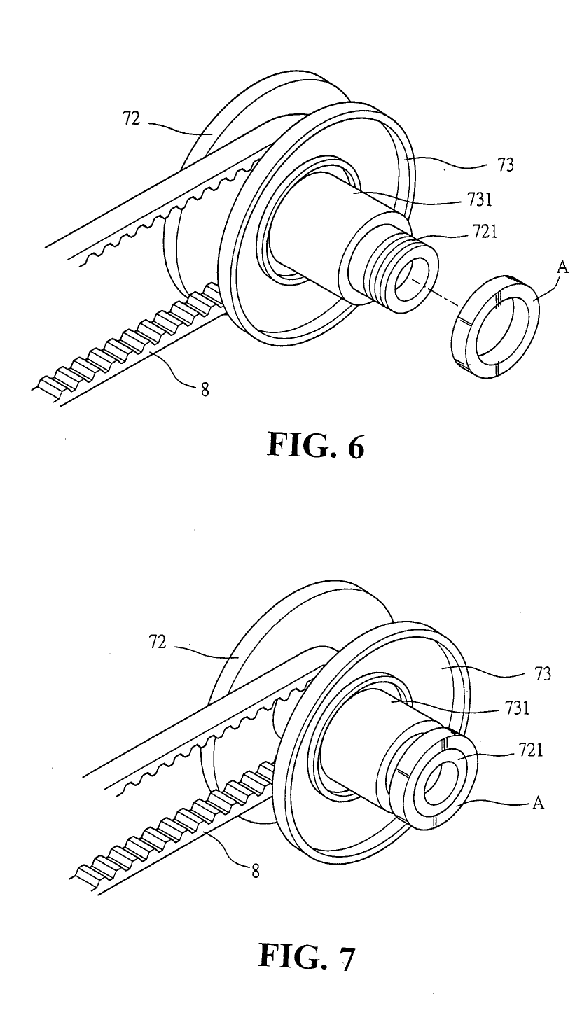

Now referring to FIGS. 5, 6 and 7, the limiting ring A is inserted onto the guide part 721 of the passive disk 72 and is located on the external side of the guide cylinder 731 of the passive disk 73. In case of throttle-up, the rpm of the crankshaft increases accordingly to throw the counter weight ball 54 out of its initial position for being subject to greater eccentric force, thus the slide disk 51 is made subject to the displacement of the counter weight ball 54 and moves toward the active disk 52 while the other passive disk 73 compresses the spiral coil 9 for the guide cylinder 731 of the passive disk 73 to slide towards the clutch 71. Meanwhile, the moving distance of the guide cylinder 731 of the passive disk 73 is restricted by the limiting ring A, and therefore the range of the rotation circumference of the transmission belt 8 on both of the passive disks 72 and 73 is limited accordingly to conduct a proper limitation to the vehicle speed without affecting the maximal torque output for acceleration or climb.

The speed limiting ring A disposed on the outer side of the end of the guide cylinder 731 of the passive disk 73 is used in the vehicle speed limiting structure of the present invention to achieve the purpose of limiting the vehicle speed.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A vehicle speed limiting apparatus having added a limiting ring to a belt transmission of a vehicle including an active disk driven by a crankshaft of an engine; a passive disk disposed on a passive shaft; and a transmission belt provided to the active disk and the passive disk to transmit the power of the engine to the passive shaft via the transmission belt is characterized by the limiting ring being adapted to the belt transmission and inserted onto a guide part of the passive disk and on the outer side of the end of the guide cylinder of the passive disk; and the travel distance of the passive disk being restricted by the limiting ring to further limit the vehicle speed.
